(19) United States
(12) Patent Application Publication
(10) Pub. No.: US 2023/0060798 A1
(43) Pub. Date: Mar. 2, 2023

(54) System and Method for Attention Detection and Visualization

(71) Applicant: Plantronics, Inc., Santa Cruz, CA (US)

(72) Inventors: Jian David Wang, Burnaby (CA); Rajen Bhatt, McDonald, PA (US); Kui Zhang, Austin, TX (US); Thomas Joseph Puorro, Dallas, TX (US); David A. Bryan, Austin, TX (US)

(21) Appl. No.: 17/871,002

(22) Filed: Jul. 22, 2022

Related U.S. Application Data
(60) Provisional application No. 63/260,564, filed on Aug. 25, 2021.

(51) Int. Cl. G06F 3/14; G06T 5/00; H04N 5/262; G06T 11/00; G06T 7/73

(52) U.S. Cl. CPC G06F 3/14; G06T 5/002; H04N 5/2624; G06T 11/001; H04N 5/2628; G06T 7/73; G06T 2207/30201; G06T 2207/20084

(57) ABSTRACT

The attention level of participants is measured and then the resulting value is provided on a display of the participants. The participants are presented in a gallery view layout. The frame of each participant is colored to indicate the attention level. The entire window is tinted in colors representing the attention level. The blurriness of the participant indicates attention level. The saturation the participant indicates attention level. The window sizes vary based on attention level. Color bars are added to provide indications of percentages of attention level over differing time periods. Neural networks are used to find the faces of the participants and then develop facial keypoint values which are used to determine gaze direction, which in turn is used to develop an attention score. The attention score is then used to determine the settings of the layout.

### CROSS-REFERENCE TO RELATED APPLICATION AND PRIORITY CLAIM

This application claims the benefit of U.S. Provisional Patent Application No. 63/260,564 entitled “System and Method for Attention Detection and Visualization,” filed Aug. 25, 2021, which is incorporated by reference in its entirety as is fully set forth herein.

### BACKGROUND

### Technical Field

This disclosure relates generally to attention monitoring of individuals participating in a meeting or videoconference.

### Description of the Related Art

Monitoring the attention of a group of listeners, be they students in a classroom or attendees of a meeting or seminar, is always challenging. Adding in a virtual element only makes the problem more difficult.

### SUMMARY

A method, apparatus, non-transitory processor readable memory, and system are provided for indicating session participant attention by determining the attention level of each participant in a session, providing a display of each participant, and providing an attention level indicator on the display of each participant indicating the attention level of the respective participant. In selected embodiments, the attention level of each participant is determined by determining a gaze direction of each participant. In other embodiments, the gaze direction is determined by using a neural network to develop facial keypoint values for each participant. In other embodiments, the gaze direction is determined by using a neural network that detects a 3-D orientation of a head for each participant. In selected embodiments, the attention level indicator is provided on the display by performing one or more of the following: displaying a video stream of each participant in a frame that is color coded to indicate the attention level of the participant displayed in said frame; by displaying first and second multi-color attention bars with a video stream of the participant, each multi-color attention bar representing a different period of time, where each multi-color attention bar includes a plurality of color sections indicating a plurality of different attention levels for the participant during the session, where each color section has a length indicating a percentage of time at each respective attention level; by displaying a video stream of each participant in a window that is tinted with a color indicating the attention level of the participant displayed in said window; by displaying a video stream of each participant in a window that is blurred with a blurriness amount indicating the attention level of the participant displayed in said window; by displaying a video stream of each participant in a window that is saturated with a saturation amount indicating the attention level of the participant displayed in said window; and by displaying a video stream of each participant in a window that is sized with a relative window size indicating the attention level of the participant displayed in said window.

### BRIEF DESCRIPTION OF THE DRAWINGS

The present invention may be understood, and its numerous objects, features and advantages obtained, when the following detailed description of a preferred embodiment is considered in conjunction with the following drawings.

FIG. 1 is an illustration of a classroom or meeting room with students or attendees.

FIG. 2 is an illustration of bounding boxes for the students or attendees of FIG. 1.

FIG. 3 is an illustration of the images inside the bounding boxes of FIG. 2 provided in a gallery view format, with additional remote students or attendees included in the gallery view format, with the boundary frames of each image indicating an attention level in accordance with selected embodiments of the present disclosure.

FIG. 4 is an illustration of FIG. 2 with the bounding boxes colored for indicating attention level in accordance with selected embodiments of the present disclosure.

FIG. 5 is an illustration of a gallery view of attendees with the boundary frames of each image and tint of the image indicating an attention level in accordance with selected embodiments of the present disclosure.

FIG. 6 is an illustration comparing an original version of a gallery view if attendees and a version in accordance with selected embodiments of the present disclosure where the level of blur indicates attention level.

FIG. 7 is an illustration comparing an original version of a gallery view if attendees and a version in accordance with selected embodiments of the present disclosure where the level of saturation indicates attention level.

FIG. 8 is an illustration of a gallery view of attendees in accordance with selected embodiments of the present disclosure where the size of the image indicates attention level.

FIG. 9 is an illustration of a gallery view of attendees in accordance with selected embodiments of the present disclosure where the boundary frames of each image indicates an attention level and including longer term and shorter term color attention bars to indicate the attention levels over longer and shorter periods of time.

FIG. 9A is FIG. 9 with the colors replaced with cross-hatching.

FIG. 10 is a flowchart for determining attention in accordance with selected embodiments of the present disclosure.

FIG. 11 is a flowchart for detecting gaze direction in accordance with selected embodiments of the present disclosure.

FIG. 12 is an illustration of keypoints of a human body as determined by a neural network.

FIG. 13 is an illustration of a meeting attendee paying attention in accordance with selected embodiments of the present disclosure.

FIG. 14 is an illustration of meeting attendee not paying attention in accordance with selected embodiments of the present disclosure.

FIG. 15 is a flowchart for calculating an attention score in accordance with selected embodiments of the present disclosure.

FIG. 16 is a flowchart for calculating attention statistics in accordance with selected embodiments of the present disclosure.

FIG. 17 is a block diagram of a codec in accordance with selected embodiments of the present disclosure.

FIG. 18 is a block diagram of a camera in accordance with selected embodiments of the present disclosure.

FIG. 19 is a block diagram of the processor units of FIGS. 17 and 18.

### DETAILED DESCRIPTION

A system, apparatus, methodology, and computer program product are described for detecting or measuring the attention level of meeting participants, and then displaying the measured attention level as a value on a display of the meeting participants. In some examples, the participants, whether local or remote or mixed, are presented in a gallery view layout. The frame of each participant is colored, such as red, yellow or green, to indicate the attention level. In some examples the entire window is tinted in colors representing the attention level. In some examples the blurriness of the participant indicates attention level, the blurrier, the more attentive. In some examples, the saturation the participant indicates attention level, the less saturated, the more attentive. In some examples, the window sizes vary based on attention level, the larger the window, the less attentive the participant. In some examples, color bars are added to provide indications of percentages of attention level over differing time periods. All of these displays allow the instructor or presenter to quickly determine the attention level of the participants and take appropriate actions.

In some examples neural networks are used to find the faces of the participants and then develop facial keypoint values. The facial keypoint values are used to determine gaze direction. The gaze direction is then used to develop an attention score. The attention score is then used to determine the settings of the layout, as described above, in use, such as red, yellow or green frames.

In the drawings and the description of the drawings herein, certain terminology is used for convenience only and is not to be taken as limiting the examples of the present disclosure. In the drawings and the description below, like numerals indicate like elements throughout.

Throughout this disclosure, terms are used in a manner consistent with their use by those of skill in the art, for example:

Computer vision is an interdisciplinary scientific field that deals with how computers can be made to gain high level understanding from digital images or videos. Computer vision seeks to automate tasks imitative of the human visual system. Computer vision tasks include methods for acquiring, processing, analyzing and understanding digital images, and extraction of high dimensional data from the real world to produce numerical or symbolic information. Computer vision is concerned with artificial systems that extract information from images. Computer vision includes algorithms which receive a video frame as input and produce data detailing the visual characteristics that a system has been trained to detect.

Machine learning includes neural networks. A convolutional neural network is a class of deep neural network which can be applied analyzing visual imagery. A deep neural network is an artificial neural network with multiple layers between the input and output layers.

Artificial neural networks are computing systems inspired by the biological neural networks that constitute animal brains. Artificial neural networks exist as code being executed on one or more processors. An artificial neural network is based on a collection of connected units or nodes called artificial neurons, which mimic the neurons in a biological brain. Each connection, like the synapses in a biological brain, can transmit a ‘signal’ to other neurons. An artificial neuron that receives a signal then processes it and can signal neurons connected to it. The signal at a connection is a real number, and the output of each neuron is computed by some non linear function of the sum of its inputs. The connections are called edges. Neurons and edges have weights, the value of which is adjusted as ‘learning’ proceeds and/or as new data is received by a state system. The weight increases or decreases the strength of the signal at a connection. Neurons may have a threshold such that a signal is sent only if the aggregate signal crosses that threshold.

Examples discussed in the present disclosure are applicable to online learning. But embodiments of the present invention can be applied to any scenario where the participants' attention is one of the important parameters for a meeting, conference, seminar, or workshop. In one example, teachers in an online learning system can work with students much more effectively and derive the complete statistics of student's attention. Those statistics are utilized by teachers to improve the online education experience.

Examples according to this invention use head pose estimation or gaze detection to determine the attention level of video conference participants and use visual effects overlaid on transmitted video or received video to identify the attention level of each participant. The attention level can be indicated as a score, development of which is discussed below, with ranges of scores indicating high, medium and low levels of attention.

In particular, examples according to this invention are applicable to the online education or meeting industry in general for use with participants having a personal camera with or without a codec. The camera is placed in front of the participants when the participants are engaged in the online education/seminar. Examples according to the invention are also applicable to group online education or meeting sessions where a high resolution camera is viewing the participants from the front of the room and has a clear view of each participant.

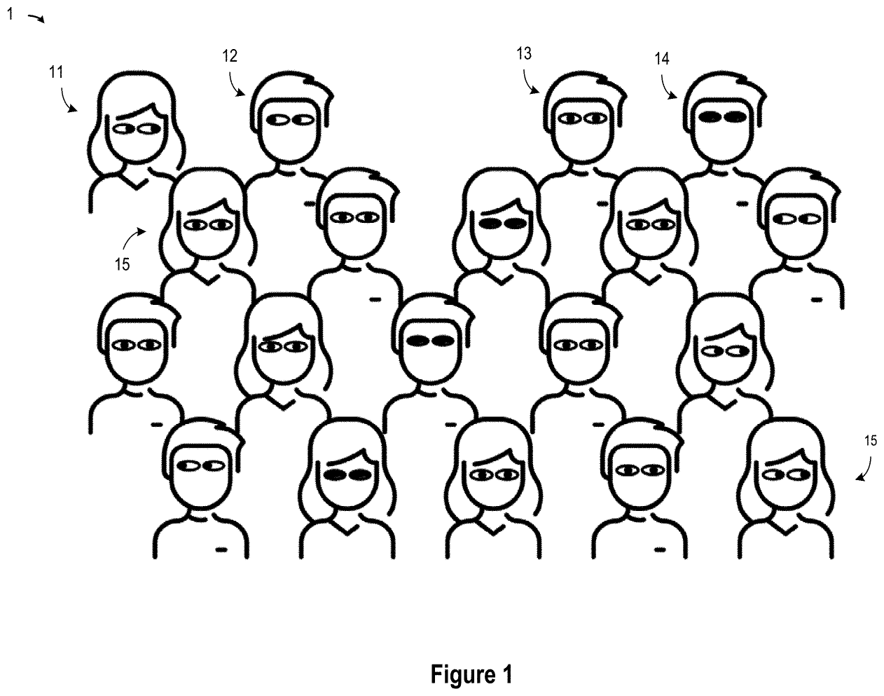

FIG. 1 shows a group view 1 of students/participants, including participants 11-15, of an online education session sitting in a classroom facing a central camera and receiving the education sessions through a centralized television/projection system. For purposes of this description, four different poses are present in the participants, though it is understood that in practice many more poses will be present, including turned heads and the like. Eyes straight ahead (e.g., 13) indicates a participant that is paying attention. Eyes directed to the right (e.g., 11) or left (e.g., 12) indicates a participant at a medium level of attention. Eyes closed (e.g., 14), to represent sleeping, indicates a bad or low level of attention.

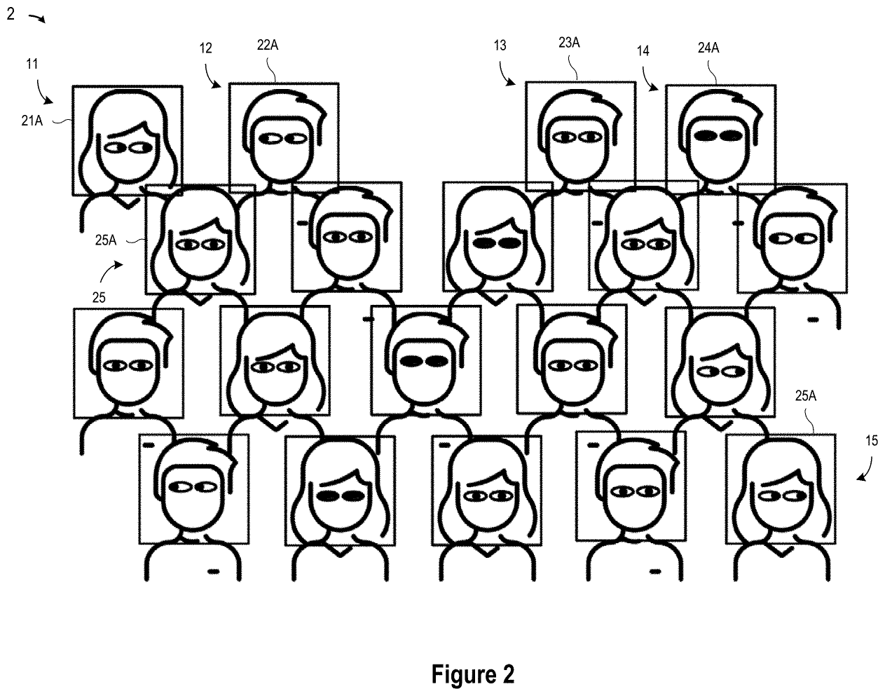

Face finding neural network operations are preferably performed on the classroom setting. The neural network operations produce bounding boxes 21A-25A for each participant 11-15 as shown in the group view 2 of FIG. 2.

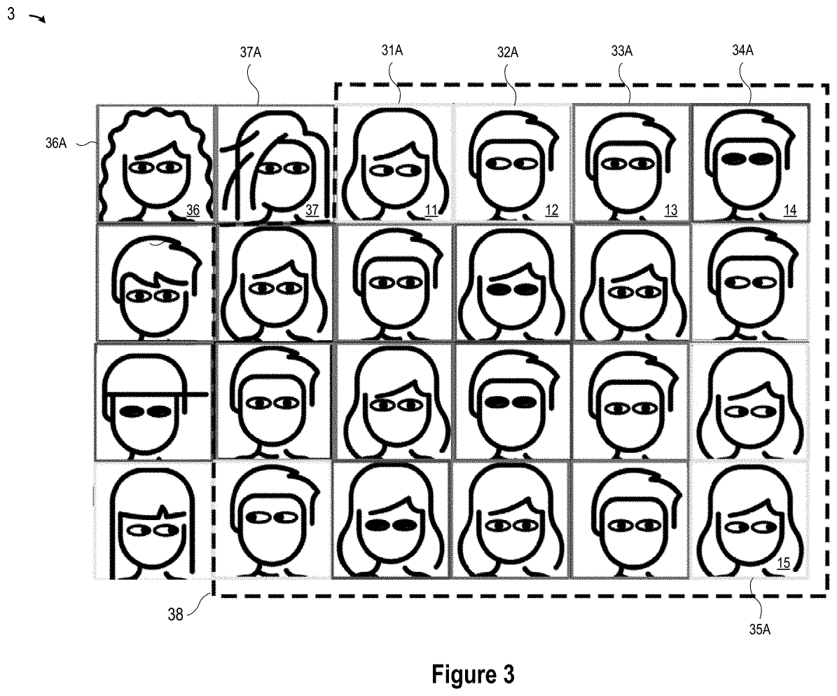

The faces inside the bounding boxes 21A-25A are then obtained and placed in a gallery view format 3, where each individual 11-15 has a separate window or frame 31A-35A. FIG. 3 illustrates the bounding boxes 21A-25A of FIG. 2 arranged in the gallery view 31A-35A as indicated by the dashed line 38. Additional windows 36A-37A are provided for remote participants 36-37. It is understood that in some cases, all of the participants may be remote, and no participants are present in the classroom, which is normal for a fully virtual class or meeting. This gallery view 3 is provided to the instructor, either as part of a videoconference display or on a separate monitor or display provided for the instructor to review participation levels. As shown in the example of FIG. 3, each window 31A-37A has a colored frame representing the attention level of that participant. For example, a green frame (e.g., 33A, 36A) indicates good attention, while a yellow frame (e.g., 31A) indicates medium attention, and a red frame (e.g., 34A) indicates bad attention. The frame colors in FIG. 3 correspond to the poses of the participant as discussed above.

With the gallery view format 3, the teacher or speaker can quickly detect how students or participants are paying attention to the lecture. If most of the rectangles 31A-37A are in red, then the teacher might pause the lecture and ask the students to pay attention through the preferred method of communication. If all of the rectangles 31A-37A are in green, then all the students are paying good attention.

In some examples, the colors used to indicate attention level have a spectrum from red to green, rather than discrete levels. That is, darker red indicates lesser amounts of attention. Other color ranges may be used.

Instead of indicating level of attention, the colors may also be used to indicate how long someone has had a lack of attention, rather than the level of lack of attention. In such an approach, darker red may indicate the participant has been not paying attention for a longer time, rather than a more severe lack of attention.

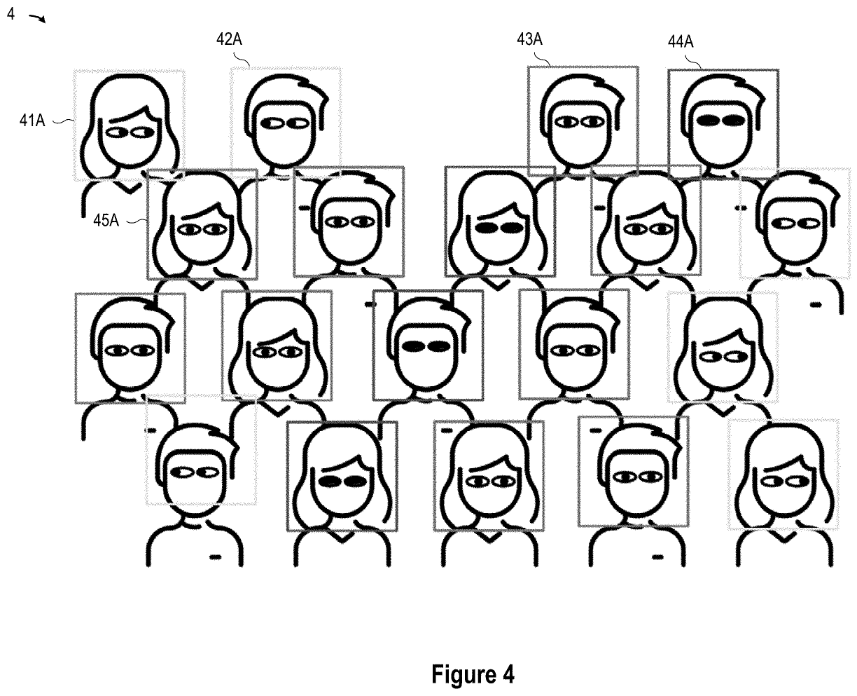

FIG. 4 illustrates an example display view 4 in accordance with selected embodiments of the present disclosure being used in a non-online setting, such as a normal classroom setting with no remote participants. In such an example, a gallery view format is not needed, as there are no remote participants to merge with the classroom participants. The display view 4 with the bounding boxes can simply have the bounding box 41A-45A be the appropriate color to indicate the attention level. Having the presented image on the display view 4 be an actual image of the classroom allows easier correlation of the attention level of each student to the view seen by the instructor on a monitor or display provided for the instructor to review the participation levels.

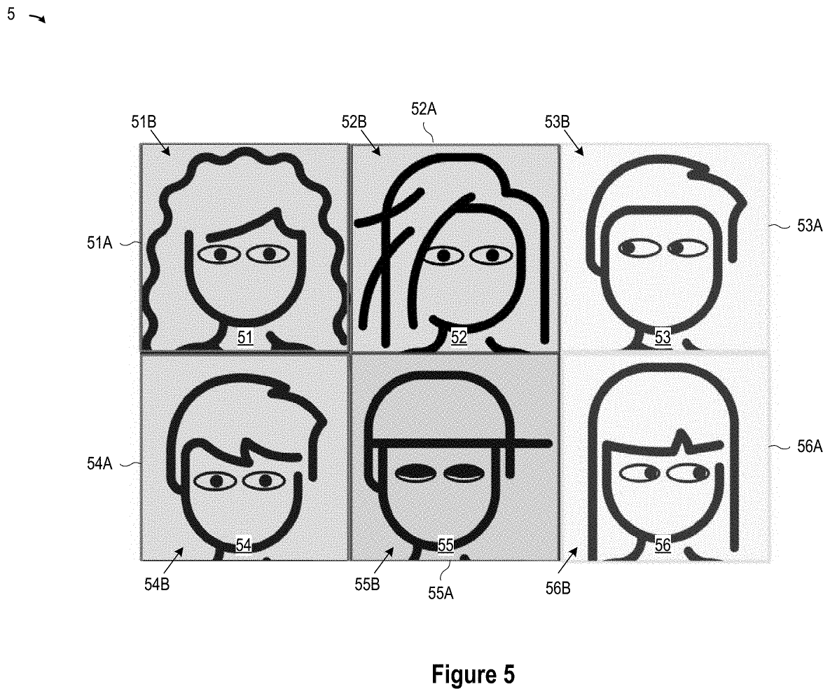

FIG. 5 is an example display view 5 where the colored frames 51A-56A indicating attention level for meeting participants 51-54 is supplemented by a tint or shade 51B-56B over the entire window. In some examples, the colored frame(s) 51A-56A can be omitted and just the tinting or shading 51B-56B performed.

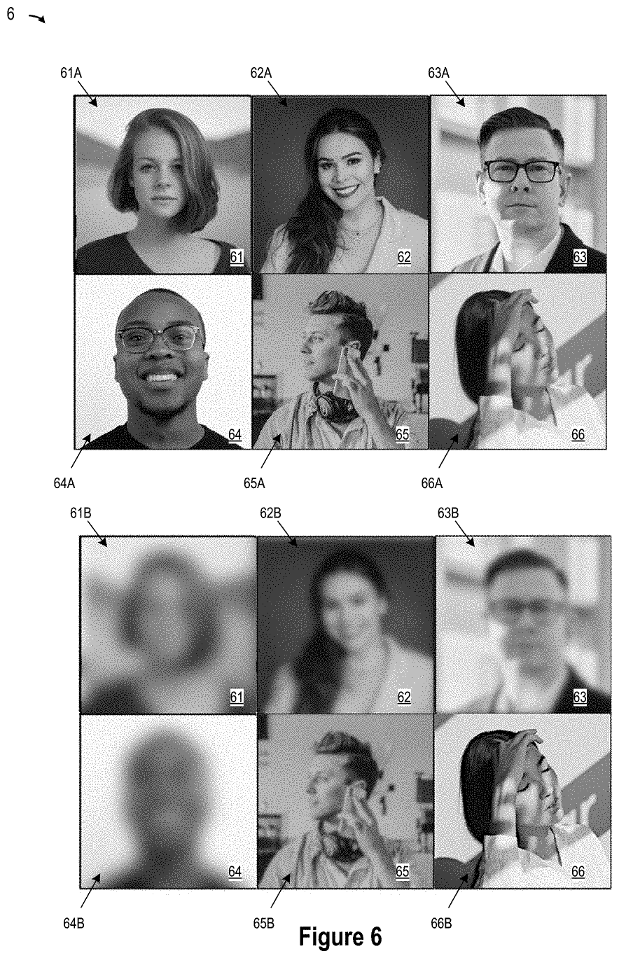

FIG. 6 is an example display view 6 where blurring is used to indicate the level of attention for the participants 61-66, rather than color. FIG. 6 includes an original image set 61A-66A at the top and a blurred image set 61B-66B at the bottom to illustrate the blurring that is being shown. Blurring particularly lends itself to a spectrum of attention level indications, rather than a few discrete levels. The participants that are the most blurred (e.g., 61B, 64B) are paying the most attention and hence have the least need to be specifically identified. The two participants in the left column 61, 64 are the most blurred, indicating the most attention. The right two participants in the top row 62, 63 have less blurring 62B, 63B, indicating a lower attention level than the two participants 61, 64 in the left column. The participant in the center of the bottom row 65 is only slightly blurred 65B, indicating a much lower attention level than the preceding two groups of participants. The participant 66 in the lower right corner is actually sharpened 66B, indicating the lowest level of attention of the examples.

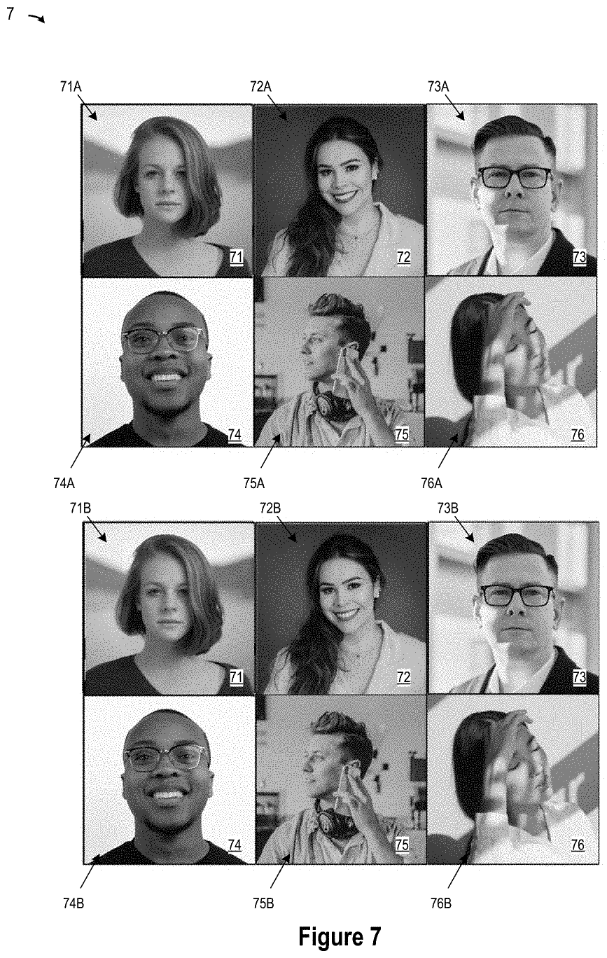

FIG. 7 is an example display view 7 where saturation is used to indicate level of attention. FIG. 7 includes an original image set 71A-76A at the top and a desaturated image set 71B-76B at the bottom. The levels of attention illustrated in FIG. 7 correspond to those of FIG. 6. The two left participants 71, 74 are fully desaturated 71B, 74B, indicating the highest level of attention; the two right participants in the top row 72, 73 are less saturated 72B, 73B, indicating a high level of attention; the participant in the bottom row center 75 is slightly desaturated 75B, indicating a lower level of attention; and the participant 76 in the lower right is more saturated 76B as compared to the original image, indicating the lowest level of attention.

Colored frames may be used with the examples of FIGS. 6 and 7 to provide further indications of attention level, such as the red, yellow and green levels of previous examples.

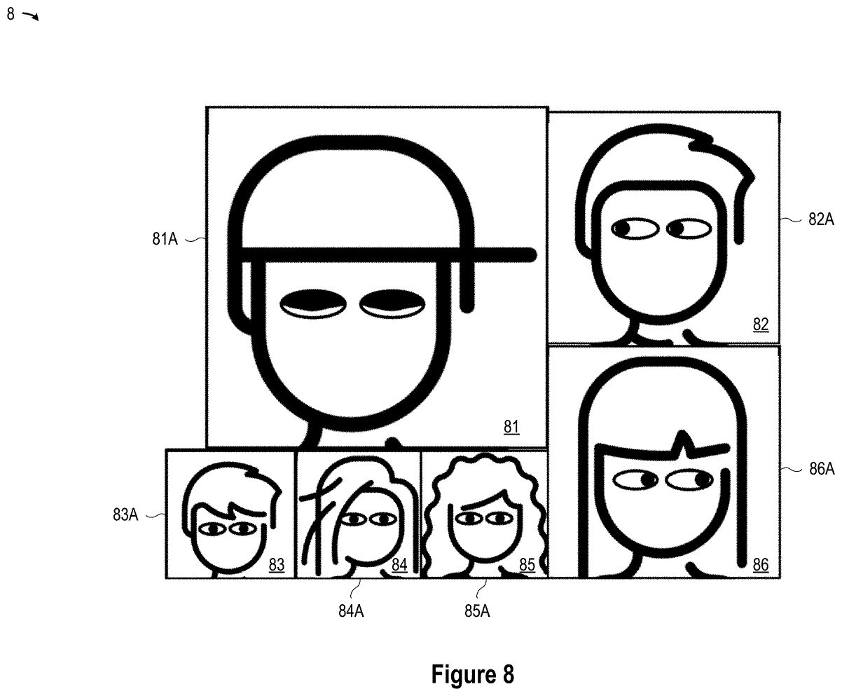

FIG. 8 is an example display view 8 where the size of the window 81A-86A reflects the attention level of the participant 81-86. In such embodiments, smaller windows (e.g., 83A-85A) indicate higher levels of attention, and larger windows (e.g., 81) indicate lower levels of attention. In selected embodiments, at the highest levels of attention the window may even disappear. The window size change is dynamic and constantly changing, shrinking and growing to draw the attention of the presenter to those that require intervention.

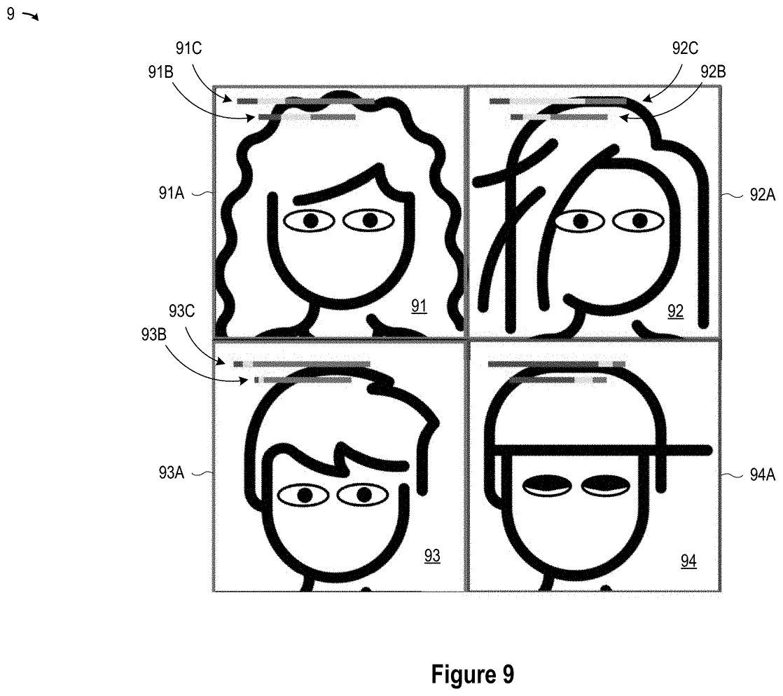

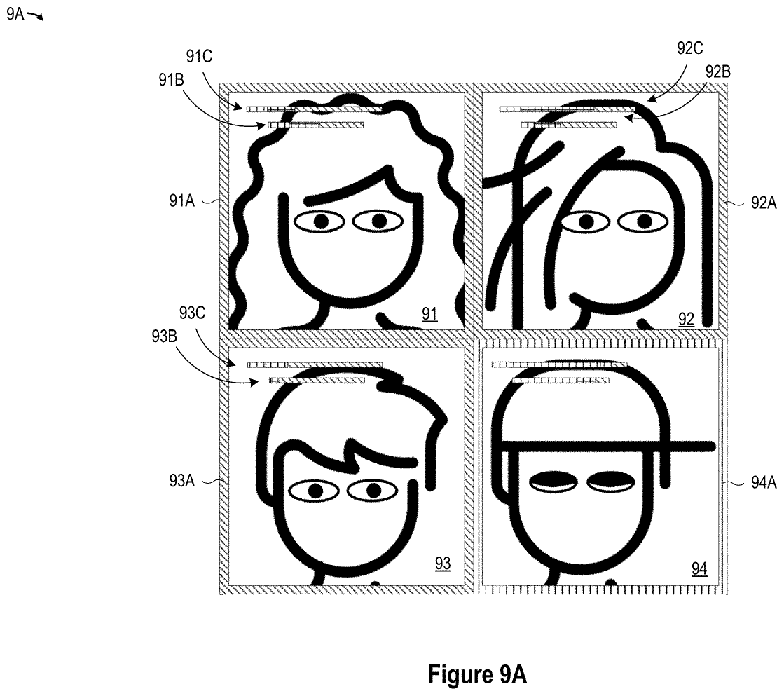

In FIG. 9, four meeting participants 91-94 are displayed with corresponding bounding boxes 91A-94A arranged in the gallery view 9. Each bounding box or window (e.g., 91A) also includes two color bars 91B, 91C. The longer color bar (e.g., 91C) shows the overall participant attention since the beginning of the lecture or class or session. The shorter color bar (e.g., 91B) shows the participant attention during the last T minutes, T being a selectable period. Each color bar may include a plurality of colors (e.g., green, yellow, and red). The length of each color in each color bar shows the percentage of the corresponding attention, and can range from 0 to 100. Referring to the two color bars 92B, 92C of the upper right participant 92, the upper color bar 92C has a large central section in yellow, indicating that, for most of the lecture, the participant has had medium levels of attention. The lower color bar 92B is primarily green, indicating that the participant has recently had higher levels of attention. In another example, not illustrated, mostly green in the upper bar and mostly red in the lower bar means the participant is paying good attention in the lecture but starts to have bad attention in last T minutes. In another example, if the upper bar is mostly red and the lower bar is mostly green, this indicates that the participant did not have good attention before but has started to listen carefully in the last T minutes. In another example, if the color bars include only a green component, then the participant is really focusing on the presentation, but if the color bars include only a red component, then the participant is not being attentive to the presentation. The frame color 91A-94A is an overall average attention level.

The values used to develop the color bars are the participant attention levels determined at periodic intervals and stored to develop the participant attention level over time.

FIG. 9A is FIG. 9 presented in an alternative symbol format.

In some examples, other cues are used to change scores to indicate a higher need of intervention by the presenter. For example, recognizing gestures that indicate the need for help, such as raised hands, a shaking head, and confused micro expressions, may indicate that the participant needs attention from the presenter, even if their “attention” score may be high. These gestures can be determined by a neural network programmed to detect a given set of gestures used to indicate a help request. In such cases of needing help, the weights discussed below used to develop an attention score may be adjusted such that the presentation mechanisms emphasize the participant in the same manner as if the participant was not paying attention. In another example, a separate score is used to indicate a level of need of help, allowing the system to call out those asking for assistance to the presenter as potentially needing intervention. This second score can lead to different colors being used on the frame than the attention colors. In one example, blue or purple is used to indicate someone is using gestures to ask for help, even if they are otherwise paying attention. In another example, color intensity or saturation is used to indicate how long that participant has indicating needing special help. In other examples, particularly if separate scores are being developed, two colored frames, an inner frame and an outer frame, can be used, one indicating attention level and the other indicating requested assistance level. In some examples, scores for both intensity of distraction, the inverse of attention, and duration of distraction may be combined using various approaches of weights, etc. to develop the attention level score.

As described above, neural networks develop bounding boxes of the participants. Software operations combined with further neural network operations are used to develop attention scores.

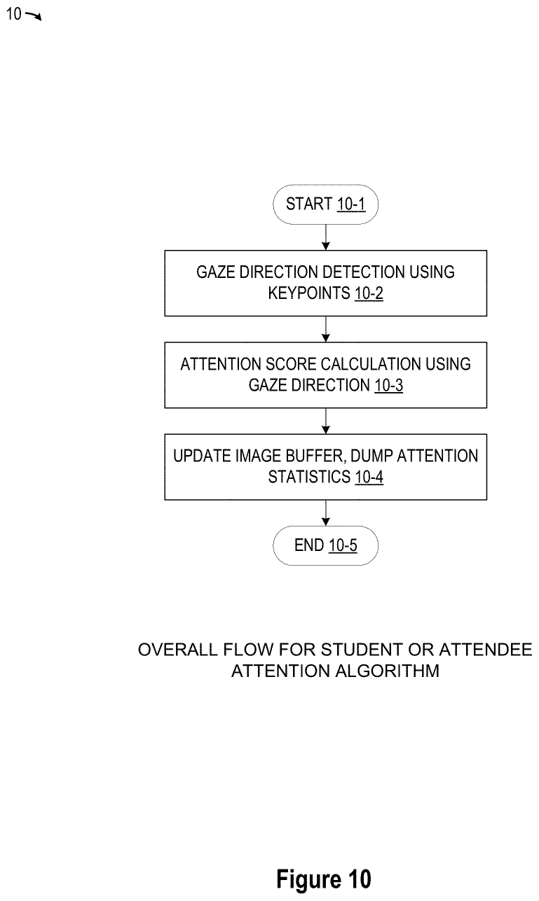

FIG. 10 shows the overall flow 10 for student or attendee attention algorithm.

There are the following steps for the student or attendee attention algorithm.

At step 10-1, the method starts.

At step 10-2, the gaze direction is detected by using facial keypoints.

At step 10-3, the attention score is calculated based on the detected gaze direction.

At step 10-4, the image buffer is updated and the attention statistics are dumped.

At step 10-5, the method ends.

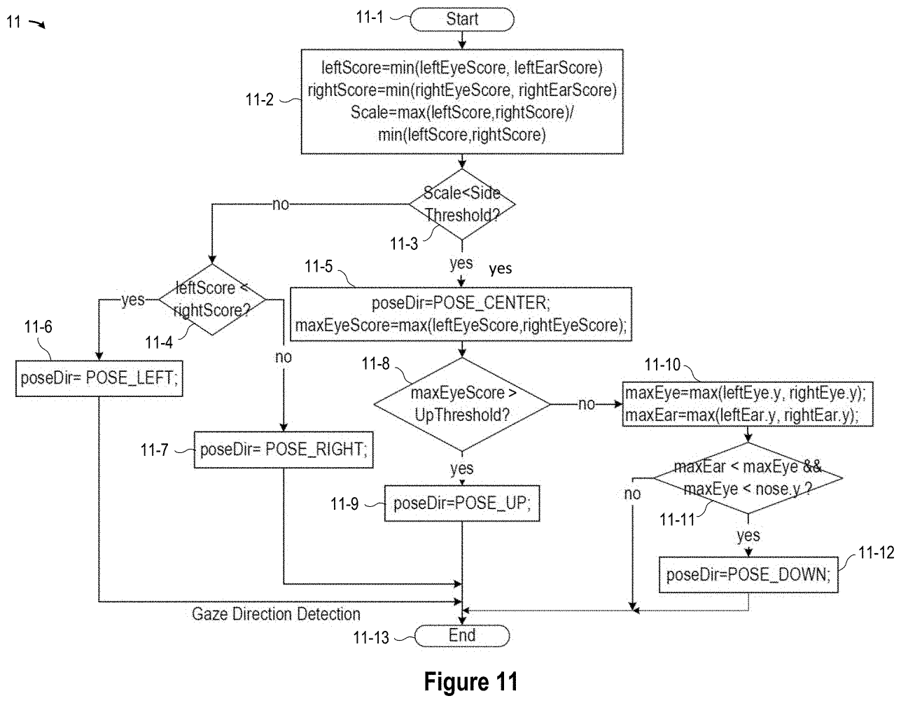

To provide additional details for an improved understanding of selected embodiments of the present disclosure, reference is now made to FIG. 11 which shows an example of logic steps 11-1 to 11-13 for gaze direction detection using facial keypoints. As depicted, the logic processing steps start (step 11-1), and five facial keypoints are measured or obtained at step 11-2 for use in detecting the gaze direction detection. The example facial keypoints may include left eye (leftEyeScore), left ear (leftEarScore), nose, right eye (rightEyeScore), and right ear (rightEarScore). These keypoints provide the 3-D orientation of the head, the yaw, pitch and roll. It is understood that other keypoints can be used and other gaze direction detection methods may be used. From those five facial points, there are five possible gaze directions as shown below:

POSE_CENTER: when the participant faces toward the camera

POSE_LEFT: when the participant faces left side to the camera

POSE_RIGHT: when the participant faces right side to the camera

POSE_UP: when the participant faces up side to the camera

POSE_DOWN: when the participant faces down side to the camera

The gaze direction detection is mainly divided into two steps. The first step is to decide if the gaze is center directions or side directions (left/right). To check that, the logic processing step 11-2 computes the min score for left side and right side. The min left score is the min of leftEyeScore and leftEarScore (e.g., leftScore=min(leftEyeScore, leftEarScore)). The min right score is the min of rightEyeScore and rightEarScore (e.g., rightScore=min(rightEyeScore, rightEarScore)). Then, the logic processing step 11-2 computes the ratio Scale value from these two scores (e.g., Scale=(max(leftScore, rightScore)/min(leftScore, rightScore))). If the logic processing step 11-3 determines that ratio Scale value is bigger than SideThreshold (negative outcome from step 11-2), then the gaze direction is a side view, not a center view. And at logic processing step 11-4, the side view gaze direction is evaluated by comparing the leftScore and rightScore. If (leftScore<rightScore), then the gaze direction is POSE_LEFT (outcome step 11-6), but otherwise the gaze direction is POSE_RIGHT (outcome step 11-7). Referring back to the logic processing step 11-3, if the ratio Scale value is less than the SideThreshold value (affirmative outcome from step 11-3), then the gaze direction is a center view (outcome step 11-5), at which point additional logic processing step check further if the direction is Up, Down, or Frontal. To check if the gaze direction is up, the logic processing step 11-5 computes the maximum of the leftEyeScore and rightEyeScore (e.g., maxEyeScore=max(leftEyeScore, rightEyeScore). If the logic processing step 11-8 determines that the maxEyeScore is greater than the upper threshold (UpThreshold) (e.g., maxEyeScore>UpThreshold) (affirmative outcome from step 11-8), then the gaze direction is POSE_UP (outcome step 11-9). However, if the logic processing step 11-8 determines that the maxEyeScore is not greater than the upper threshold (e.g., maxEyeScore<UpThreshold) (negative outcome from step 11-8), then logic processing steps check if the gaze direction is down. To check down gaze direction, the logic processing step 11-10 computes the maxEye value (e.g., maxEye=max (leftEye.y, rightEye.y)) and the maxEar value (e.g., maxEar=max (leftEar.y, rightEar.y)). If the logic processing step 11-11 determines that (maxEar<maxEye && maxEye<nose.y) (affirmative outcome from step 11-11, then the gaze direction is POSE_DOWN (outcome step 11-12). But if the logic processing step 11-11 does not determine that maxEar<maxEye && maxEye<nose.y (negative outcome from step 11-11), then the gaze direction is Frontal or centered, and the processing logic steps end (step 11-13).

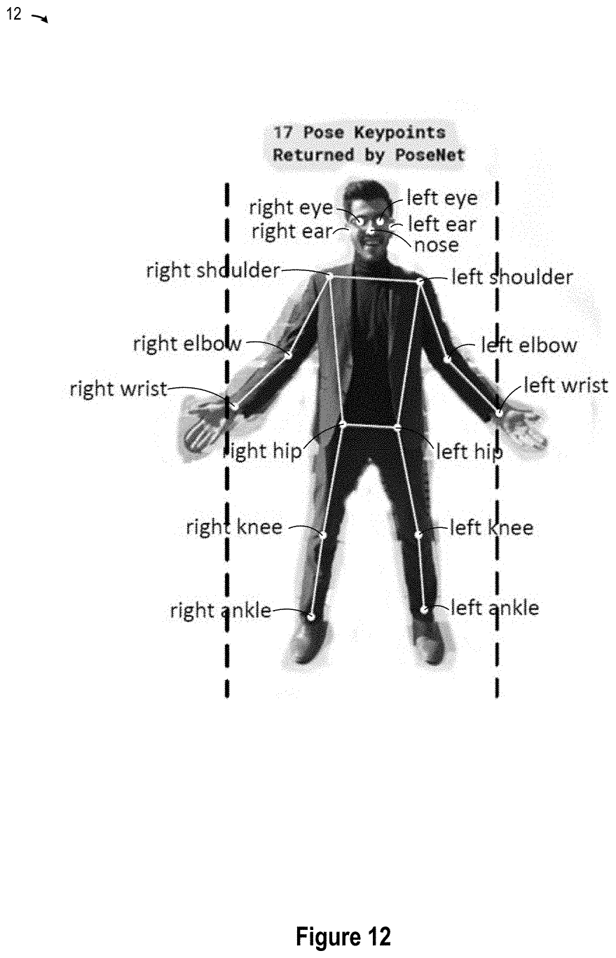

To provide additional details for an improved understanding of selected embodiments of the present disclosure, reference is now made to FIG. 12 which illustrates the keypoints of a human body as determined by a neural network, such as Posenet. For example, there are 17 exemplary pose keypoints, including a noise keypoint along with left and right eye, ear, shoulder, elbow, wrist, hip, knee, and ankle keypoints.

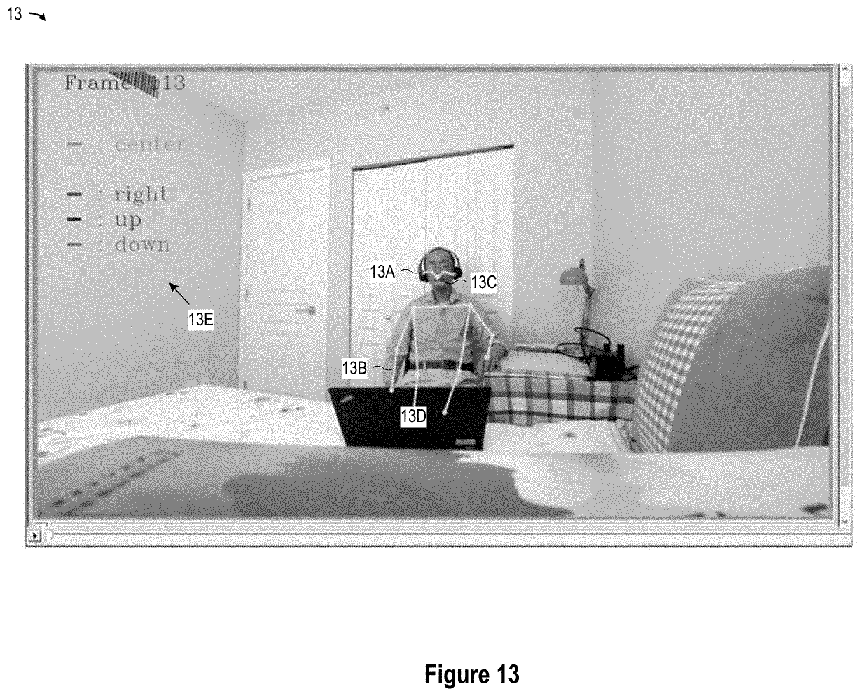

To provide additional details for an improved understanding of selected embodiments of the present disclosure, reference is now made to FIG. 13 which depicts an illustration 13 of a meeting attendee paying attention. As depicted, FIG. 13 depicts example keypoints 13A, 13B and a color-coded attention direction indicator 13C for a participant who is paying attention with the gaze centered toward the video display 13D. In particular, there are depicted ears, eyes, and nose keypoints 13A, shoulder, elbow, wrist, hip, and knee keypoints 13B, and a pose direction indicator 13C which is colored to indicate a centered pose (as indicated by the color legend grid 13E where “green” indicates a centered pose direction). For each keypoint, there is score and position information. The higher the score, the more likely the feature is present. For example, if the nose score is 0.99, then the possibility of the nose feature is 99%.

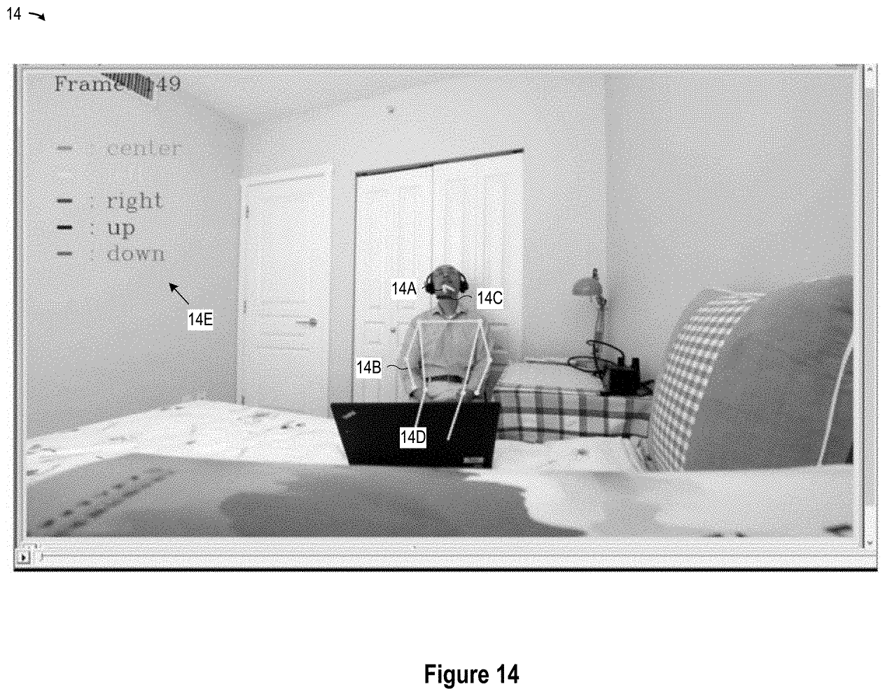

To provide additional details for an improved understanding of selected embodiments of the present disclosure, reference is now made to FIG. 14 which depicts an illustration 14 of a meeting attendee who is distracted and not paying attention. As depicted, FIG. 14 depicts example keypoints 14A, 14B and a color-coded attention direction indicator 14C for a participant who is not paying attention with the gaze looking up from the video display 14D. In particular, there are depicted ears, eyes, and nose keypoints 14A, shoulder, elbow, wrist, hip, and knee keypoints 14B, and a pose direction keypoint 14C which is colored to indicate an upward pose (as indicated by the color legend grid 14E where “blue” indicates a upward pose direction).

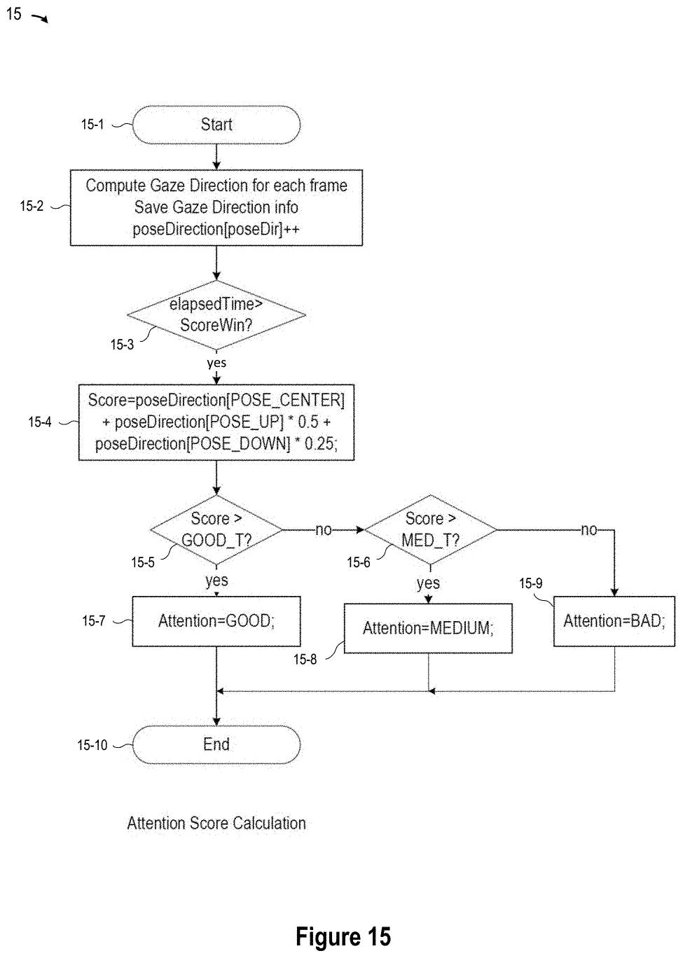

To provide additional details for an improved understanding of selected embodiments of the present disclosure, reference is now made to FIG. 15 which shows a flowchart of the logic steps 15-1 to 15-10 for calculating the attention score. Once the depicted logic processing starts (step 15-1), the gaze direction is computed at logic processing step 15-2, such as by using the computational logic from FIG. 11 to compute the gaze direction for each frame. If the logic processing step 15-3 determines that elapsed time is more than the time limit (e.g., ScoreWin=6 seconds) (affirmative outcome from step 15-3), then the logic processing step 15-4 computes the attention Score at logic processing step 15-4. For example, the score may be computed as Score=poseDirection[POSE_CENTER]+poseDirection[POSE_UP]*0.5+poseDirection[POSE_DOWN]*0.25. At logic processing step 15-5, the attention score (Score) is compared to a first predetermined threshold (e.g., GOOD_T=60%). If the attention Score is above GOOD_T (affirmative outcome from step 15-5), then the current attention index is set to GOOD (outcome step 15-7). However, if the attention Score is NOT above GOOD_T (negative outcome from step 15-5), then the logic processing step 15-6 compares the attention Score to a second predetermined threshold (e.g., MED_T=40%). If the attention Score is above MED_T (affirmative outcome from step 15-8), then the current attention index is set to MEDIUM (outcome step 15-8). Otherwise, the attention index is set to BAD (outcome step 15-9).

As will be appreciated, additional or different threshold values can be used. For displays like blurring, saturation or window size, the attention score can be used directly in determining the amount of effect applied.

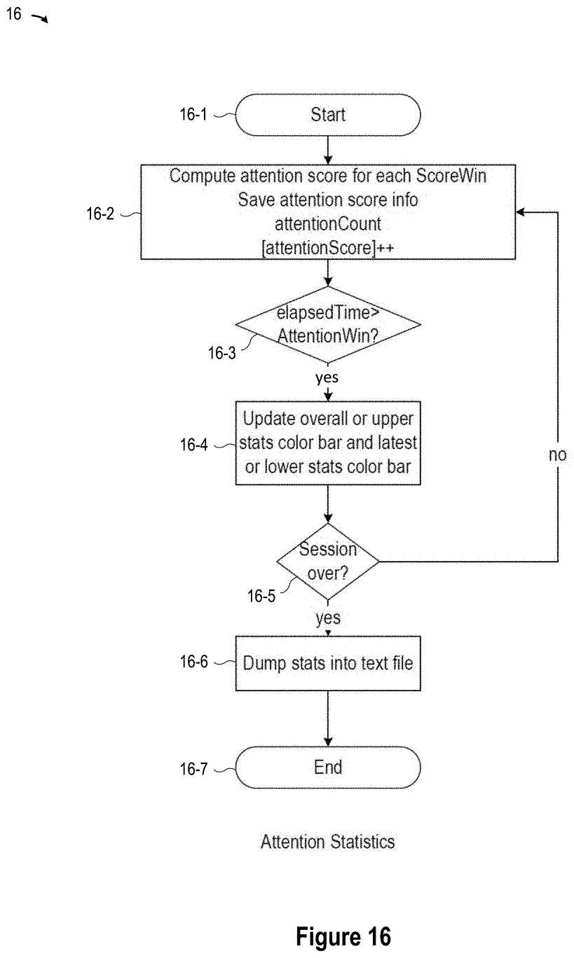

To provide additional details for an improved understanding of selected embodiments of the present disclosure, reference is now made to FIG. 16 which shows a flowchart of the logic steps 16-1 to 16-7 for calculating attention statistics. Once the depicted logic processing starts (step 16-1), the attention score is computed for each ScoreWin at logic processing step 16-2, such as by using the computational logic from FIG. 15 to compute the attention score. In addition, the computed attention scores are saved into an attentionCount array, such as by updating an attentionCount value ([attentionScore]++). If the logic processing step 16-3 determines that the elapsed time is more than an attention window time limit (e.g., AttentionWin=120 seconds) (affirmative outcome from step 16-3), then the logic processing step 16-4 updates the overall (or upper) stats color bar and the latest (or lower) stats color bar at logic processing step 16-4. The length of each component in each color bar corresponds to its percentage. The range for each component could be 0 to 100. If the logic processing step 16-5 determines that the session is over (affirmative outcome from step 16-5), then the logic processing step 16-6 dumps the attention stats into a text file (step 16-6) and the process ends (step 16-7).

At the end of the session, the session statistics file can also be sent to the teacher or presenter for further analysis and to generate valuable information about students/participants. As disclosed herein, the attention statistics in the session statistics file can include information identifying the student(s)/participant(s), the session start and end dates/times, and a listing of individual and cumulative attention scores from a plurality of attention measurement intervals for each student/participant.

In this description, head pose has been used as the metric for determining attention, but other metrics (for example, eye gaze position, eye gaze dwell time, eye movement, micro expressions, non-visual cues (e.g., audio), etc.) may be used in the attention determination calculation. And in other embodiments, the attention determination calculation may weigh several of these metrics. In addition, the attention determination calculation may incorporate time-based metrics (for example, sliding windows of attention, etc.) to determine a score that will be used for the attention level of the participant, and to determine how that participant is presented, allowing the presenter or instructor to know which participants may require intervention.

Here is a description of a few typical use cases:

School Online Courses—the software on the teacher side receives student session data for each class. The software generates the overall summary of student attention statistics for each student on each class. This information should be helpful for the teacher to build student report card.

Meeting participant attention analysis—for senior-level management people, who spend most of the time on online video meetings and the efficiency of those meetings is very important. Apply the technique described in this disclosure to analyze the participant attention in the meetings and help to improve the efficiency of the meetings. For example, consider the case for a recurrent meeting with 12 participants. The organizer collects the attention report for each participant after the meeting. If some participants never show good attention, the organizer might remove those participants from the meeting since they are not interested anyway.

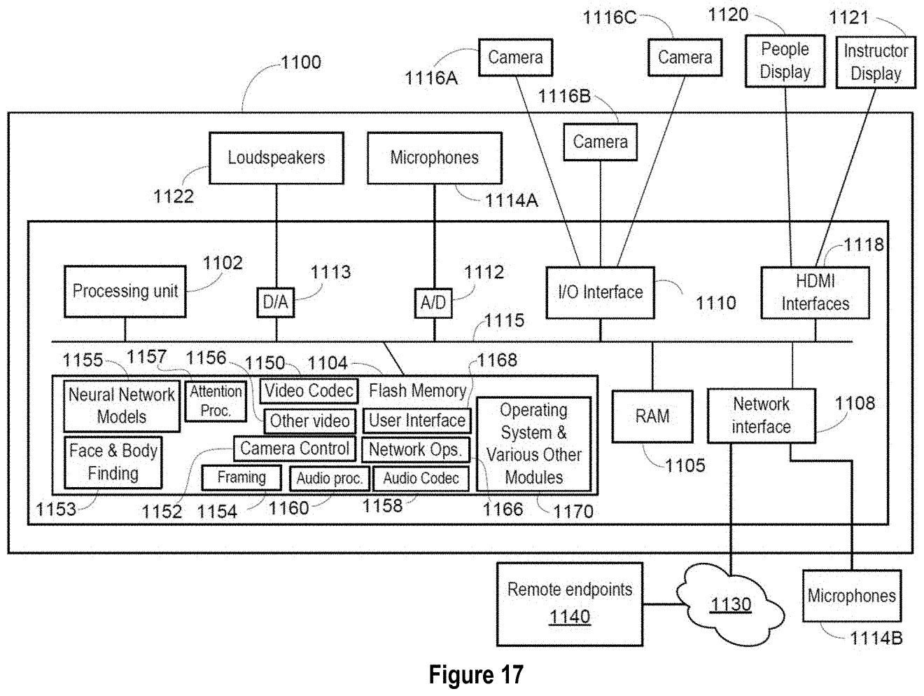

To provide additional details for an improved understanding of selected embodiments of the present disclosure, reference is now made to FIGS. 17, 18 and 19 which provide an example of a videoconferencing endpoint for performing the neural network operations, developing the gallery view and presenting the attention results on a display in a classroom, auditorium or conference room. In other examples, such as a fully virtual environment, a USB camera is connected to a laptop or desktop computer of the instructor and software present in the laptop or desktop computer performs the various operations to develop the desired attention gallery display layout. Preferably the laptop or desktop computer contains a discrete graphics chip to assist in performing the neural network operations.

Referring now to FIG. 17, there are illustrated aspects of a codec 1100 in accordance with selected embodiments of the present disclosure. The codec 1100 may include loudspeaker(s) 1122 (though in many cases the loudspeaker 1122 is provided in the monitor display 1120) and microphone(s) 1114A interfaced via interfaces to a bus 1115. In particular, the microphones 1114A are interfaced through an analog to digital (A/D) converter 1112, and the loudspeaker 1122 is interfaced through a digital to analog (D/A) converter 1113. The codec 1100 also includes a processing unit 1102, a network interface 1108, a flash memory 1104, RAM 1105, and an input/output (I/O) general interface 1110, all coupled by bus 1115. The camera(s) 1116A, 1116B, 1116C are illustrated as connected to the I/O interface 1110. Microphone(s) 1114B are connected to the network interface 1108. HDMI interfaces 1118 are connected to the bus 1115 and to the people external display or monitor 1120 and the instructor display or monitor 1121. The people monitor 1120 acts as the normal far site display in a videoconference. The instructor display 1121 presents the attention results gallery layout or other desired layout to provide the participant attention displays as described above. Bus 1115 is illustrative and any interconnect between the elements can used, such as Peripheral Component Interconnect Express (PCIe) links and switches, Universal Serial Bus (USB) links and hubs, and combinations thereof. The cameras 1116A, 1116B, 1116C and microphones 1114A, 1114B can be contained in housings containing the other components or can be external and removable, connected by wired or wireless connections, or camera 1116B can be built into the codec 1100. In some examples, the main camera 1116B can be built into the codec 1100, with this example shown in FIG. 17.

The processing unit 1102 can include digital signal processors (DSPs), central processing units (CPUs), graphics processing units (GPUs), dedicated hardware elements, such as neural network accelerators and hardware codecs, and the like in any desired combination.

The flash memory 1104 stores modules of varying functionality in the form of software and firmware, generically programs, for controlling the codec 1100. Illustrated modules include a video codec 1150, camera control 1152, face and body finding 1153, neural network models 1155, framing 1154, other video processing 1156, attention processing 1157, audio codec 1158, audio processing 1160, network operations 1166, user interface 1168 and operating system and various other modules 1170. The RAM 1105 is used for storing any of the modules in the flash memory 1104 when the module is executing, storing video images of video streams and audio samples of audio streams and can be used for scratchpad operation of the processing unit 1102. The face and body finding 1153 and neural network models 1155 are used in the various operations of the codec 1100, such as the face detection and gaze detection. The attention processing module 1157 performs the operations of FIGS. 10, 11, 15, and 16 and develops the gallery or bounding box layouts as illustrated in FIGS. 3-9, the layouts presented on the instructor monitor 1121.

The network interface 1108 enables communications between the codec 1100 and other devices and can be wired, wireless or a combination. In one example, the network interface 1108 is connected or coupled to the Internet 1130 to communicate with remote endpoints 1140 in a videoconference. In one or more examples, the general interface 1110 provides data transmission with local devices such as a keyboard, mouse, printer, projector, display, external loudspeakers, additional cameras, and microphone pods, etc.

In one example, the cameras 1116A, 1116B, 1116C and the microphones 1114 capture video and audio, respectively, in the videoconference environment and produce video and audio streams or signals transmitted through the bus 1115 to the processing unit 1102. In at least one example of this disclosure, the processing unit 1102 processes the video and audio using algorithms in the modules stored in the flash memory 1104. Processed audio and video streams can be sent to and received from remote devices coupled to network interface 1108 and devices coupled to general interface 1110. This is just one example of the configuration of a codec 1100.

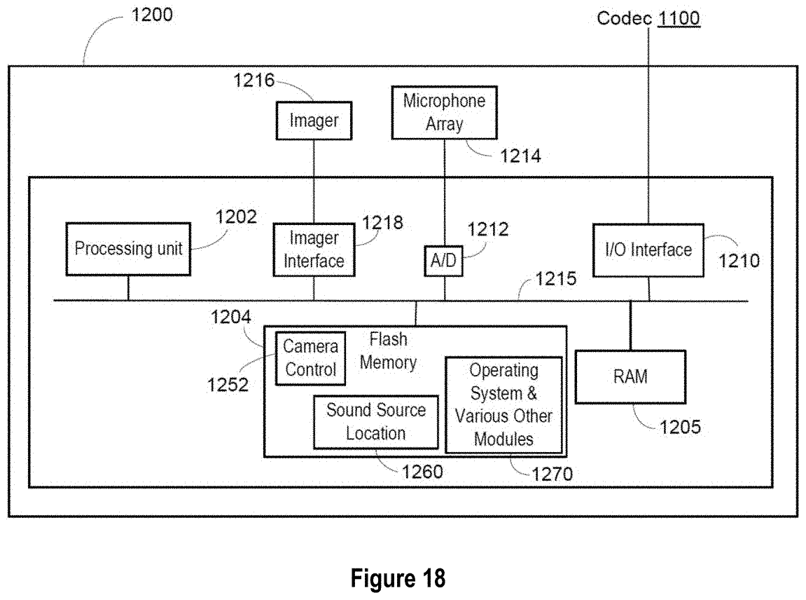

Referring now to FIG. 18, there are illustrated aspects of a camera 1200 that is separate from the codec 1100 in accordance with selected embodiments of the present disclosure. The camera 1200 includes an imager or sensor 1216 and a microphone array 1214 interfaced via interfaces to a bus 1215. In particular, the microphone array 1214 is interfaced through an analog to digital (A/D) converter 1212, and the imager 1216 is interfaced through an imager interface 1218. The camera 1200 also includes a processing unit 1202, a flash memory 1204, RAM 1205, and an input/output general interface 1210, all coupled by bus 1215. Bus 1215 is illustrative and any interconnect between the elements can used, such as Peripheral Component Interconnect Express (PCIe) links and switches, Universal Serial Bus (USB) links and hubs, and combinations thereof. The codec 1100 is connected to the I/O interface 1210, preferably using a USB interface.

The processing unit 1202 can include digital signal processors (DSPs), central processing units (CPUs), graphics processing units (GPUs), dedicated hardware elements, such as neural network accelerators and hardware codecs, and the like in any desired combination.

The flash memory 1204 stores modules of varying functionality in the form of software and firmware, generically programs, for controlling the camera 1200. Illustrated modules include camera control 1252, sound source localization 1260 and operating system and various other modules 1270. The RAM 1205 is used for storing any of the modules in the flash memory 1204 when the module is executing, storing video images of video streams and audio samples of audio streams and can be used for scratchpad operation of the processing unit 1202.

In a second configuration, only the main camera 1116B includes the microphone array 1214 and the sound source location module 1260. Cameras 1116A, 1116C are then just simple cameras. In a third configuration, the main camera 1116B is built into the codec 1100, so that the processing unit 1202, the flash memory 1204, RAM 1205 and I/O interface 1210 are those of the codec 1100, with the imager interface 1218 and A/D 1212 connected to the bus 1115.

Other configurations, with differing components and arrangement of components, are well known for both videoconferencing endpoints and for devices used in other manners.

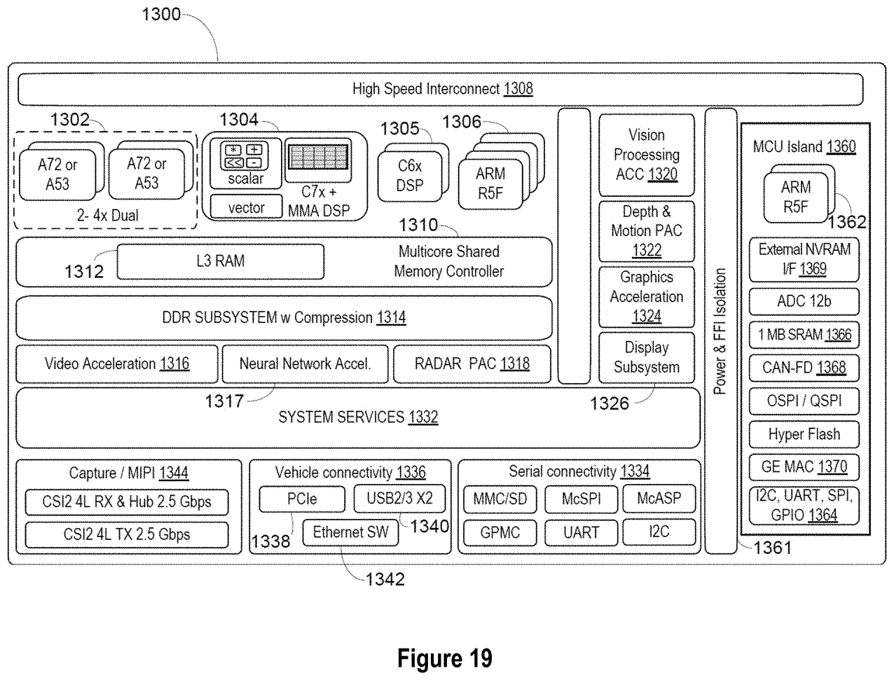

Referring now to FIG. 19, there is illustrated a block diagram of an exemplary system on a chip (SoC) 1300 as can be used as the processing unit 1102 or 1202. A series of more powerful microprocessors 1302, such as ARM® A72 or A53 cores, form the primary general purpose processing block of the SoC 1300, while a more powerful digital signal processor (DSP) 1304 and multiple less powerful DSPs 1305 provide specialized computing capabilities. A simpler processor 1306, such as ARM R5F cores, provides general control capability in the SoC 1300. The more powerful microprocessors 1302, more powerful DSP 1304, less powerful DSPs 1305 and simpler processor 1306 each include various data and instruction caches, such as L1I, L1D, and L2D, to improve speed of operations. A high speed interconnect 1308 connects the microprocessors 1302, more powerful DSP 1304, simpler DSPs 1305 and processors 1306 to various other components in the SoC 1300. For example, a shared memory controller 1310, which includes onboard memory or SRAM 1312, is connected to the high speed interconnect 1308 to act as the onboard SRAM for the SoC 1300. A DDR (double data rate) memory controller system 1314 is connected to the high speed interconnect 1308 and acts as an external interface to external DRAM memory. The RAM 1105 or 1205 are formed by the SRAM 1312 and external DRAM memory. A video acceleration module 1316 and a radar processing accelerator (PAC) module 1318 are similarly connected to the high speed interconnect 1308. A neural network acceleration module 1317 is provided for hardware acceleration of neural network operations. A vision processing accelerator (VPACC) module 1320 is connected to the high speed interconnect 1308, as is a depth and motion PAC (DMPAC) module 1322.

A graphics acceleration module 1324 is connected to the high speed interconnect 1308. A display subsystem 1326 is connected to the high speed interconnect 1308 to allow operation with and connection to various video monitors. A system services block 1332, which includes items such as DMA controllers, memory management units, general purpose I/O's, mailboxes and the like, is provided for normal SoC 1300 operation. A serial connectivity module 1334 is connected to the high speed interconnect 1308 and includes modules as normal in an SoC. A vehicle connectivity module 1336 provides interconnects for external communication interfaces, such as PCIe block 1338, USB block 1340 and an Ethernet switch 1342. A capture/MIPI module 1344 includes a four lane CSI 2 compliant transmit block 1346 and a four lane CSI 2 receive module and hub.

An MCU island 1360 is provided as a secondary subsystem and handles operation of the integrated SoC 1300 when the other components are powered down to save energy. An MCU ARM processor 1362, such as one or more ARM R5F cores, operates as a master and is coupled to the high speed interconnect 1308 through an isolation interface 1361. An MCU general purpose I/O (GPIO) block 1364 operates as a slave. MCU RAM 1366 is provided to act as local memory for the MCU ARM processor 1362. A CAN bus block 1368, an additional external communication interface, is connected to allow operation with a conventional CAN bus environment in a vehicle. An Ethernet MAC (media access control) block 1370 is provided for further connectivity. External memory, generally non-volatile memory (NVM) such as flash memory 104, is connected to the MCU ARM processor 1362 via an external memory interface 1369 to store instructions loaded into the various other memories for execution by the various appropriate processors. The MCU ARM processor 1362 operates as a safety processor, monitoring operations of the SoC 1300 to ensure proper operation of the SoC 1300.

It is understood that this is one example of an SoC provided for explanation and many other SoC examples are possible, with varying numbers of processors, DSPs, accelerators and the like.

By using face finding and gaze detection, attention levels of conference or class participants are developed. The attention levels for each participant are provided on a display for the use of the teacher, instructor or presenter. Numerous options are described for providing the display, one being providing the participants in a gallery view format and color coding the frame of each participant window to the appropriate attention level. Tinting, blurring or saturating the participant window can be used to display the participant attention level. Window size can be varied based on attention level. Multiple color bars can be used to provide the attention level percentages for different time periods for each participant. All of these alternative display formats provide feedback to the instructor, teacher or presenter of the attention level of the participants, allowing the instructor, teacher or presenter to take remedial action as needed.

Computer program instructions may be stored in a non-transitory processor readable memory that can direct a computer or other programmable data processing apparatus, processor or processors, to function in a particular manner, such that the instructions stored in the non-transitory processor readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

The various examples described are provided by way of illustration and should not be construed to limit the scope of the disclosure. Various modifications and changes can be made to the principles and examples described herein without departing from the scope of the disclosure and without departing from the claims which follow.

What is claimed is:

1. A method of indicating session participant attention, the method comprising:
determining an attention level of each participant in a session;
providing a display of each participant; and
providing an attention level indicator on the display of each participant indicating the attention level of the respective participant.

2. The method of claim 1, wherein providing the display comprises displaying each respective participant in a frame arranged in a gallery view format, and
wherein displaying the attention level indicator comprises color coding each frame to indicate the attention level of the respective participant displayed in said frame.

3. The method of claim 2, wherein displaying the attention level indicator comprises displaying first and second multi-color attention bars in each frame, each multi-color attention bar representing a different period of time, where each multi-color attention bar comprises a plurality of color sections indicating a plurality of different attention levels for the respective participant during the session, where each color section has a length indicating a percentage of time at each respective attention level.

4. The method of claim 1, wherein providing the display comprises displaying each respective participant in a window arranged in a gallery view format, and
wherein displaying the attention level indicator comprises tinting each window with a color indicating the attention level of the respective participant displayed in said window.

5. The method of claim 1, wherein providing the display comprises displaying each respective participant in a window arranged in a gallery view format, and
wherein displaying the attention level indicator comprises blurring each window with a blurriness amount indicating the attention level of the respective participant displayed in said window, with more blurring indicating a higher level of attention.

6. The method of claim 1, wherein providing the display comprises displaying each respective participant in a window arranged in a gallery view format, and
wherein displaying the attention level indicator comprises saturating each window with a saturation amount indicating the attention level of the respective participant displayed in said window, with less saturation indicating a higher level of attention.

7. The method of claim 1, wherein providing the display comprises displaying each respective participant in a window arranged in a gallery view format, and
wherein displaying the attention level indicator comprises sizing each window with a relative window size indicating the attention level of the respective participant displayed in said window, with a larger window indicating a lower attention level.

8. The method of claim 1, wherein determining the attention level of each participant comprises determining a gaze direction of each participant.

9. The method of claim 8, wherein determining the gaze direction comprises using a neural network to develop facial keypoint values for each participant.

10. The method of claim 8, wherein determining the gaze direction comprises using a neural network that detects a 3-D orientation of a head for each participant.

11. A system comprising:
a monitor that displays a first video stream for a participant in a session; and
processing unit coupled to receive the first video stream for the participant and to display the first video stream on the monitor, where the processing unit is configured to determine, from the first video stream, an attention level of the participant that is measured over time during the session and to display an attention level indicator on the monitor indicating the attention level of the participant.

12. The system of claim 11, wherein the processing unit is coupled to the monitor to display a plurality of video streams from a corresponding plurality of session participants in a plurality of frames arranged on the monitor in a gallery view format, where each frame is color coded to indicate the attention level of the participant displayed in said frame.

13. The system of claim 11, wherein the processing unit is coupled to the monitor to display the attention level indicator by displaying first and second multi-color attention bars with the first video stream, each multi-color attention bar representing a different period of time, where each multi-color attention bar comprises a plurality of color sections indicating a plurality of different attention levels for the participant during the session, where each color section has a length indicating a percentage of time at each respective attention level.

14. The system of claim 11, wherein the processing unit is coupled to the monitor to display the attention level indicator by displaying the first video stream in a window that is tinted with a color indicating the attention level of the participant displayed in said window.

15. The system of claim 11, wherein the processing unit is coupled to the monitor to display the attention level indicator by displaying the first video stream in a window that is blurred with a blurriness amount indicating the attention level of the participant displayed in said window.

16. The system of claim 11, wherein the processing unit is coupled to the monitor to display the attention level indicator by displaying the first video stream in a window that is saturated with a saturation amount indicating the attention level of the participant displayed in said window.

17. The system of claim 11, wherein the processing unit is coupled to the monitor to display the attention level indicator by displaying the first video stream in a window that is sized with a relative window size indicating the attention level of the participant displayed in said window.

18. The system of claim 11, wherein the processing unit is configured to determine the attention level of the participant by using a neural network to develop facial keypoint values for the participant which are used to determine a gaze direction of the participant.

19. A non-transitory processor readable memory containing programs that when executed cause a processor or processors to perform a method for indicating session participant attention, the method comprising:
determining an attention level of each participant in a session;
providing a display of each participant; and
providing an attention level indicator on the display of each participant indicating the attention level of the respective participant.

20. The non-transitory processor readable memory of claim 19, wherein providing the attention level indicator on the display comprises one or more of the following:
displaying a video stream of the participant in a frame that is color coded to indicate the attention level of the participant displayed in said frame;
displaying first and second multi-color attention bars with a video stream of the participant, each multi-color attention bar representing a different period of time, where each multi-color attention bar comprises a plurality of color sections indicating a plurality of different attention levels for the participant during the session, where each color section has a length indicating a percentage of time at each respective attention level;
displaying a video stream of the participant in a window that is tinted with a color indicating the attention level of the participant displayed in said window;
displaying a video stream of the participant in a window that is blurred with a blurriness amount indicating the attention level of the participant displayed in said window;
displaying a video stream of the participant in a window that is saturated with a saturation amount indicating the attention level of the participant displayed in said window; and
displaying a video stream of the participant in a window that is sized with a relative window size indicating the attention level of the participant displayed in said window.
